(19) United States
(12) Patent Application Publication
(10) Pub. No.: US 2013/0273241 A1
(43) Pub. Date: Oct. 17, 2013

(54) METHOD OF MAKING LENS

(71) Applicants: Ching-Shan Yang, Tainan (TW); Wu-Li Wang, Tainan (TW)

(72) Inventors: Ching-Shan Yang, Tainan (TW); Wu-Li Wang, Tainan (TW)

(73) Assignee: GLOBAL MICROPTICS COMPANY, Tainan (TW)

(21) Appl. No.: 13/446,435

(22) Filed: Apr. 13, 2012

(51) Int. Cl. B05D 5/06; G02B 1/12; B29D 11/00

(52) U.S. Cl. 427/164; 264/2.7; 264/1.36; 264/1.38

(57) ABSTRACT

A method of making lenses includes the following steps: A. Provide a photo-curing material into a cavity between a first die and a second die. B. Expose the photo-curing material under predetermined light, whereby the photo-curing material is solidified, and a transmittance of the solidified photo-curing material is greater than 75%. C. Remove the first die and the second die to obtain a lens material; and D. Cut the lens material to obtain a plurality of lenses.

### BACKGROUND OF THE INVENTION

1. Field of the Invention

The present invention relates generally to an optical device, and more particularly to a method of making lenses.

2. Description of the Related Art

In recent days, consumer electronic devices, such as cell phone, laptop, tablet, and PDA, are equipped with lens module to catch images. These consumer electronic devices are made as smaller and lighter as possible for user to carry and operate in an easy way so that lens modules and the lens mounted in the lens module are asked smaller and lighter accordingly.

A conventional method of making such lens includes the following steps:

A. Provide molten thermosetting epoxy on a glass substrate, and flip a first die on the epoxy and press it.

B. Heat the epoxy for curing to form a first lens portion on a side of the glass substrate.

C. Remove the first die.

D. Provide molten thermosetting epoxy on the other side of the glass substrate, and flip a second die on the epoxy and press it.

E. Heat the epoxy for curing to form a second lens portion on the other side of the glass substrate.

F. Remove the second die to obtain a lens with the first lens portion and the second lens portion on opposite side of the glass substrate.

It will take a long time to mold a lens by the conventional method as described above because it only molds a side of the lens once. Besides, the lens made by the conventional method has a glass substrate therein. It is obviously that the glass substrate limits the thickness of the lens. Therefore, it still has some places to be improved.

### SUMMARY OF THE INVENTION

The primary objective of the present invention is to provide a method of making a lens, which makes thin lenses in a fast way.

According to the objective of the present invention, a method of making lenses includes the following steps:

A. Provide an optical material into a cavity between a first die and a second die.

B. Solidify the optical material to form a lens material, wherein a transmittance of the lens material is greater than 75%.

C. Removing the second die from the lens material, and then moving at least a pin toward the lens material to separate the lens material from the first die; and

D. Cut the lens material to obtain a plurality of lenses.

In an embodiment, the step A further includes the steps of putting a bulk of the optical material on the second die, and pressing the first die onto the second die to fill the cavity with the optical material.

In an embodiment, the step A further includes the step of providing the molten optical material into the cavity.

In an embodiment, the optical material is photo-curing material, and the photo-curing material is exposed under predetermined light for curing in the step B.

In an embodiment, the photo-curing material is UV-curing material, and the UV-curing material is exposed under UV light for curing in the step B.

In an embodiment, the optical material is photo-curing epoxy.

In an embodiment, both the first die and the second die are transparent.

In an embodiment, the optical material is thermosetting material, and the thermosetting material is heated for curing in the step B.

In an embodiment, the thermosetting material is thermosetting epoxy.

In an embodiment, both the first die and the second die are made of high thermal conductivity material.

In an embodiment, an adhesion force between the first die and the lens material is greater than an adhesion force between the second die and the lens material so that the second die is separated from the lens material prior to the first die in the step C.

In an embodiment, the first die is provided with at least a hole, and the pin is inserted into the hole to be moved, further wherein a distal end of the pin is received in the hole of the first die in the step A, and extends out of the hole when the pin is moved in the step C to touch the lens material and separate the lens material from the first die.

In an embodiment, the cavity has a plurality of lens portions, in which the lenses are molded, and the hole of the first die extends to a portion between the lens portions so that the pin touches the lens material at a portion between the lenses.

In an embodiment, the method of the present invention further includes the step of coating an IR cut filter on the lens material prior to the step D.

In an embodiment, one of the first die and the second die has a flat side, and the other has a cavity.

In an embodiment, both the first die and the second die respectively have a cavity.

In an embodiment, the transmittance of the solidified photo-curing material is greater than 95%.

Therefore, the present invention is faster than the conventional method, and the lenses made by the method of the present invention are thinner and lighter than the lenses made by the conventional method.

### BRIEF DESCRIPTION OF THE DRAWINGS

FIG. 1 is a flow chart of a preferred embodiment of the present invention;

FIG. 2 and FIG. 3 are sketch diagrams of the step A of the preferred embodiment of the present invention;

FIG. 4 and FIG. 5 are sketch diagrams of the step C of the preferred embodiment of the present invention; and

FIG. 6 is sketch diagram of the step D of the preferred embodiment of the present invention.

### DETAILED DESCRIPTION OF THE INVENTION

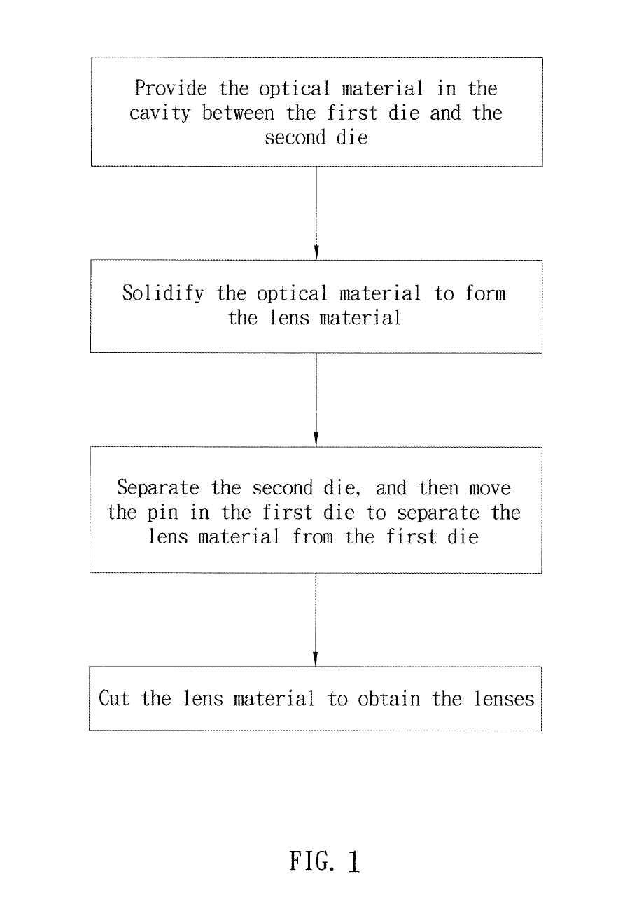

As shown in FIG. 1, a method of making lenses of the preferred embodiment of the present invention includes the following steps:

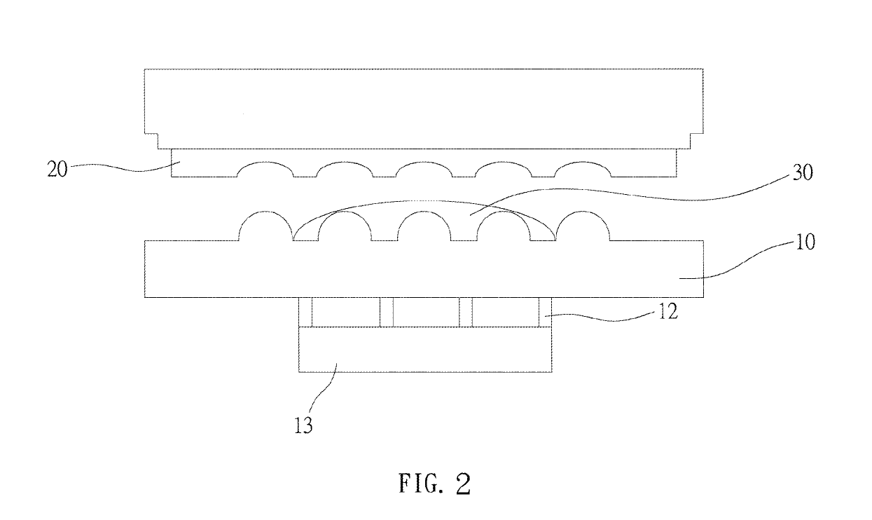

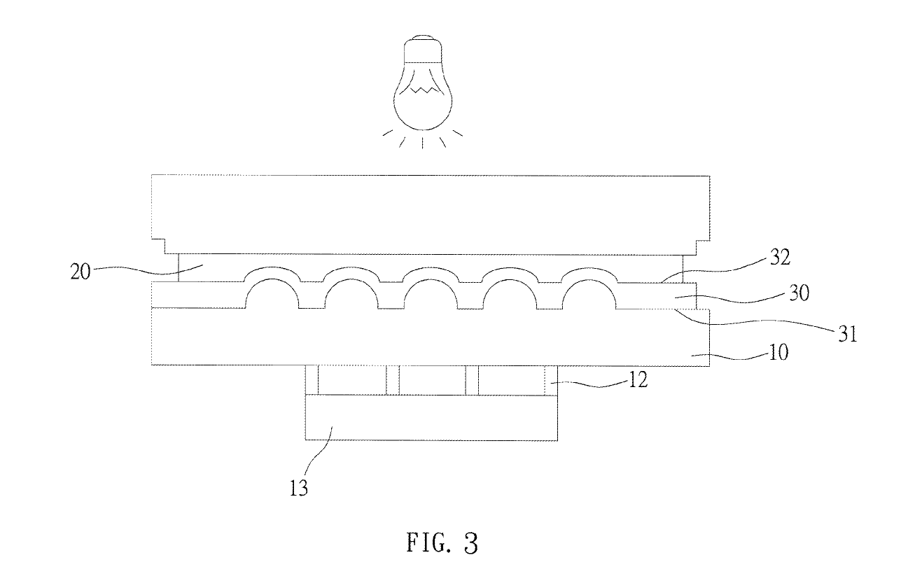

A. As shown in FIG. 2 and FIG. 3, provide a molten optical material 30 in a cavity between a first die 10 and a second die 20. The first die 10 and the second die 20 respectively have a recess to form the cavity. The cavity has several lens portions, in each of which a lens will be molded, and a runner communicating the lens portions. The first die 10 is provided with a plurality of holes extending to runner of the cavity, between the lens portions, and a plurality of pins 12 are inserted into the holes to be moved. A base 13 is provided to connect to the pins 12 so that operator may move all the pins 12 at the same time by operating the base 13. The pins 12 are longer than a thickness of the first die 10 so that distal ends of the pins 12 may enter the cavity when one pushes the base 13, and the distal ends of the pins 12 are received in the holes at this stage. In the present embodiment, the optical material is photo-curing material, and more preferable is UV-curing epoxy. A bulk of UV-curing epoxy 30 is put on the second die 20, and then the first die 10 is put on second die 20 and pressed to press the epoxy 30 to let it fill the entire cavity between the first die 10 and the second die 20. An alternate way is pouring or injecting the molten UV-curing epoxy into the cavity.

B. Solidify the optical material to form a lens material. In the present embodiment, the first die 10 and the second die 20 are transparent, and an UV lamp is moved above the dies 10, 20 to illuminate the UV-curing epoxy 30 through the die in order to solidify it and form the lens material 30. In an embodiment, a transmittance of the lens material 30 is greater than 75%, and more preferable is greater than 95%. Many facts, such as the photo-curing material used for molding, the amount of the photo-curing material put in the cavity, and the shape and size of the cavity, limit the light for curing, the time of exposure, and intensity of the light, one having ordinary skill in material molding may easily find the best combination. After curing, the lens material 30 has a first adhesion force with the first die 10 and a second adhesion force with the second die 20, and the first adhesion force is greater than the adhesion force.

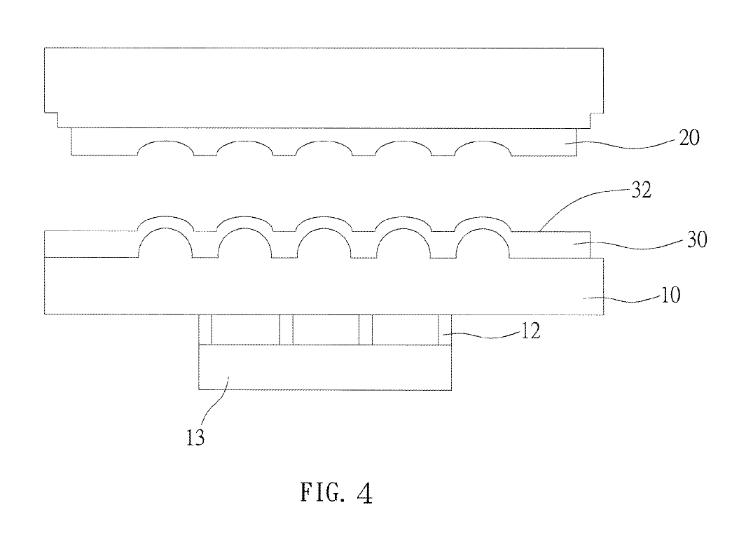

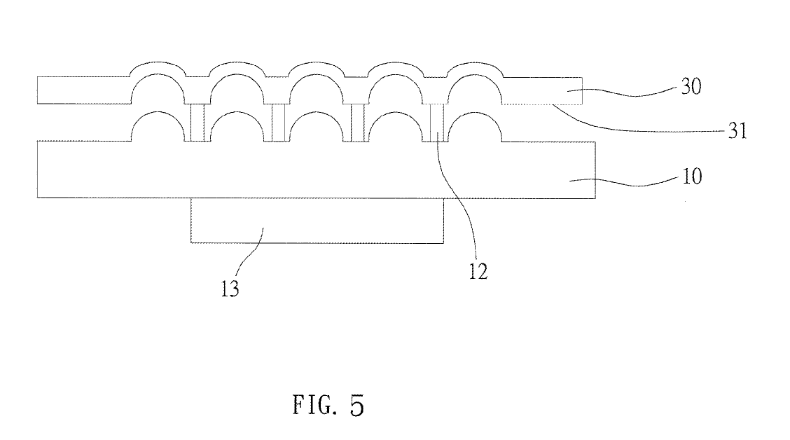

C. Remove the second die 20 from the first die 10 and the lens material 30, and then moving the pins 12 toward the lens material 30 to remove the first die 10 from the lens material 30. In the present embodiment, as shown in FIG. 4, because of the difference of the adhesion forces, the second die 20 is separated from the lens material 30 first, and the lens material 30 still is attached to the first die 10 when pulling the dies 10, 20 to separate them. At this stage, it may coat a predetermined optical film, such as IR cut filter, on the lens material 30 to provide the lenses with predetermined optical functions. Next, as shown in FIG. 5, push the base 13 toward the first die 10 to let the distal ends of the pins 12 extend out of the holes and touch the lens material 30 to separate the lens material 30 from the first die 10.

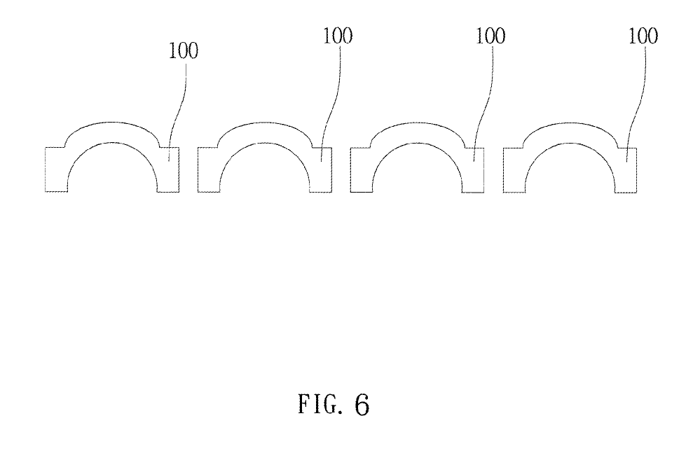

D. Cut the lens material 30 to obtain a plurality of lenses 100 (FIG. 6). It is easy to understand that it may cut the lens material 30 before the separating device 40 is removed. In the step C, the pins 12 touch the lens material 30 at portions between the lenses 100. In other words, the portions of the lens material 30 touched by the pins 12 are where the lens material 30 is cut in the present step that may protect the lenses 100 from being damaged by the pins 12.

Except for the photo-curing epoxy used in the embodiment of the present invention, it may use thermosetting epoxy in the step A, and heat the thermosetting epoxy for curing in the step B. Besides, the dies may be made of a material with high thermal conductivity to shorten the time of curing.

The lenses 100, as shown in FIG. 6, made by the method of the present invention has no glass substrate, therefore, the lenses 100 will be thinner and lighter than the conventional lenses as described in the prior art.

In above embodiment both dies have a recess to form the cavity. In practice, one of the dies may be flat and the other one has the recess so that the lens will have a flat side. The description above is a few preferred embodiments of the present invention and the equivalence of the present invention is still in the scope of claim construction of the present invention.

What is claimed is:

1. A method of making lenses, comprising the steps of:
A. providing an optical material into a cavity between a first die and a second die;
B. curing the optical material to form a lens material, wherein a transmittance of the lens material is greater than 75%;
C. removing the second die from the lens material, and then moving at least a pin toward the lens material to separate the lens material from the first die; and
D. cutting the lens material to obtain a plurality of lenses.

2. The method as defined in claim 1, wherein the step A further comprising the steps of putting a bulk of the optical material on the second die, and pressing the first die onto the second die to fill the cavity with the optical material.

3. The method as defined in claim 1, wherein the step A further comprising the step of providing the molten optical material into the cavity.

4. The method as defined in claim 1, wherein the optical material is photo-curing material, and the photo-curing material is exposed under predetermined light for curing in the step B.

5. The method as defined in claim 4, wherein the photo-curing material is UV-curing material, and the UV-curing material is exposed under UV light for curing in the step B.

6. The method as defined in claim 4, wherein the optical material is photo-curing epoxy.

7. The method as defined in claim 4, wherein both the first die and the second die are transparent.

8. The method as defined in claim 1, wherein the optical material is thermosetting material, and the thermosetting material is heated for curing in the step B.

9. The method as defined in claim 8, wherein the thermosetting material is thermosetting epoxy.

10. The method as defined in claim 8, wherein both the first die and the second die are made of high thermal conductivity material.

11. The method as defined in claim 1, wherein an adhesion force between the first die and the lens material is greater than an adhesion force between the second die and the lens material so that the second die is separated from the lens material prior to the first die in the step C.

12. The method as defined in claim 1, wherein the first die is provided with at least a hole, and the pin is inserted into the hole to be moved, further wherein a distal end of the pin is received in the hole of the first die in the step A, and extends out of the hole when the pin is moved in the step C to touch the lens material and separate the lens material from the first die.

13. The method as defined in claim 12, wherein the cavity has a plurality of lens portions, in which the lenses are molded, and the hole of the first die extends to a portion between the lens portions so that the pin touches the lens material at a portion between the lenses.

14. The method as defined in claim 1, further comprising the step of coating an IR cut filter on the lens material prior to the step D.

15. The method as defined in claim 1, wherein one of the first die and the second die has a flat side, and the other has a recess to form the cavity.

16. The method as defined in claim 1, wherein both the first die and the second die respectively have a recess to form the cavity.

17. The method as defined in claim 1, wherein the transmittance of the lens material is greater than 95%.
